(19) United States
(12) Patent Application Publication
(10) Pub. No.: US 2007/0009212 A1
(43) Pub. Date: Jan. 11, 2007

(54) OPTOELECTRONIC MODULE AND MANUFACTURING METHOD OF SAID MODULE

(75) Inventors: Francesco Martini, Alzate Brianza (Como) (IT); Pietro Montanini, Milano (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.l., Agrate Brianza (MI) (IT)

(21) Appl. No.: 11/428,707

(22) Filed: Jul. 5, 2006

(30) Foreign Application Priority Data
Jul. 6, 2005 (IT) MI2005A001280

(51) Int. Cl. G02B 6/36

(52) U.S. Cl. 385/92; 385/94

(57) ABSTRACT

An optoelectronic module includes a first sub-module and a second sub-module. The first sub-module has a surface with a cavity formed therein, and includes an integrated waveguide provided with a first optical port accessible from the cavity. The second sub-module faces the first sub-module. A metallic wall extends from the first sub-module to the second sub-module, and surrounds the cavity to define a hermetically closed chamber. An optoelectronic device is coupled to at least one of the first and second sub-modules, and is included in the chamber. The optoelectronic may comprise a second optical port coupled to the first optical port in the first sub-module.

### FIELD OF THE INVENTION

The present invention relates to the field of optical telecommunications, and more particularly, to an optoelectronic module.

### BACKGROUND OF THE INVENTION

The request for high speed data access and the consequential need for greater bandwidths for different applications, such as those on the Internet or Ethernet, have recently increased interests towards high capacity optical fibers. Nevertheless, implementation of fiber optic networks that directly reach the home or office of a user is currently quite costly.

The non-economical nature of such service is in part due to the considerable manufacture cost of the of the optoelectronic modules to be installed at each user. Normally, such optoelectronic modules comprise an optoelectronic device of a transmitting type (such as a semiconductor laser) and/or an optoelectronic device of a receiving type (such as a photodiode) to be coupled to an optical fiber connected to the network.

For various reasons, the reduction of the manufacturing costs of the optical modules has not been an easy-to-reach objective. Indeed, one reason is tied to the need to ensure an adequate coupling optical efficiency between the devices employed in the module and the optical fiber connected to the network. This requires the use of high precision equipment, along with difficult mounting procedures.

Moreover, the need to make modules having hermetic characteristics leads to the consequential use of costly materials regarding the packaging of the modules themselves. The problems summarized above have been addressed in different ways by conventional technologies without attaining truly satisfying results.

For example, U.S. Pat. No. 6,164,836 refers to an integrated hybrid optoelectronic circuit comprising a silicon substrate, a dielectric optical waveguide integrated in the substrate and an optical device mounted on the substrate. It is noted that one such optoelectronic module does not assure adequate hermetic closure of the region housing the optical device, and consequently, requires use of an expensive external hermetic package of a metallic and/or ceramic type.

According to another method, described in U.S. Pat. No. 5,559,918, an optical module is proposed having a base body, a semiconductor optical device, an optical fiber arranged in a groove of the base body, and a cover element of the fiber and of the device fixed to the substrate. This approach appears to be complex and difficult to manufacture with regards to the number, the type (i.e., use of optical fibers) and the aligning methods of the optical components making up part of the module.

### SUMMARY OF THE INVENTION

An object of the present invention is to provide an optoelectronic module, particularly of the type used for optical telecommunications, and an alternative to those known and which have, for example, relatively low manufacturing costs as well as satisfactory performances in terms of coupling efficiency.

This and other objects, advantages and features in accordance with the present invention are provided by an optoelectronic module comprising first and second sub-modules. The first sub-module may has cavity formed therein and includes an integrated waveguide having a first optical port accessible from the cavity. The second sub-module faces the first sub-module. A metallic wall may extend from the first sub-module to the second sub-module, and surrounds the cavity to define a hermetically closed chamber. An optoelectronic device may be coupled to at least one of the first and second sub-modules and is contained within the hermetically closed chamber. The optoelectronic device may have a second optical port coupled to the first optical port of the first sub-module.

Another aspect of the present invention is directed to a manufacturing process for an optoelectronic module as defined above.

### BRIEF DESCRIPTION OF THE DRAWINGS

To better understand the invention and appreciate its advantages, several of its exemplifying and non-limiting embodiments are described below, with reference to the attached drawings, wherein:

FIGS. 1, 2 and 3 show several lateral and sectional views related to the initial manufacturing steps of an optoelectronic sub-module in accordance with one embodiment of the invention;

FIG. 4 shows a sectional view of the optoelectronic sub-module in an intermediate manufacturing step in accordance with the invention;

FIG. 5 shows a perspective view of the optoelectronic sub-module in another intermediate manufacturing step in accordance with the invention;

FIGS. 6 and 7 respectively show a lateral view and a plan view of a laser mountable on the optoelectronic sub-module in accordance with the invention;

FIG. 8 shows a perspective view of the optoelectronic sub-module in a final manufacturing step in accordance with the invention;

FIGS. 9 and 10 show sectional views related to the initial manufacturing steps of an optical sub-module in accordance with the invention;

FIG. 11 shows a perspective view of the optical sub-module in a final manufacturing step in accordance with the invention;

FIGS. 12 and 13 show the assembly steps of the optoelectronic sub-module with the optical sub-module to obtain an optoelectronic module in accordance with the invention;

FIGS. 14 and 15 respectively show a lateral sectional part and a lateral section of the optoelectronic module in accordance with the invention;

FIG. 16 shows a sectional view of an optoelectronic module in accordance with another embodiment of the invention;

FIG. 17 schematically shows a lateral sectional view of a first triplexer made according to a first embodiment of the invention;

FIG. 18 shows in greater detail a perspective view of the first triplexer shown in FIG. 17;

FIG. 19 shows a portion of the first triplexer, including an optical fiber, in exploded view, in accordance with the invention;

FIG. 20 schematically shows a lateral sectional view of a second triplexer made according to a second embodiment of the invention;

FIG. 21 shows in greater detail a perspective view of the second triplexer shown in FIG. 20; and

FIG. 22 schematically shows a lateral sectional view of yet another manufactured embodiment of the optoelectronic module.

### DETAILED DESCRIPTION OF THE PREFERRED EMBODIMENTS

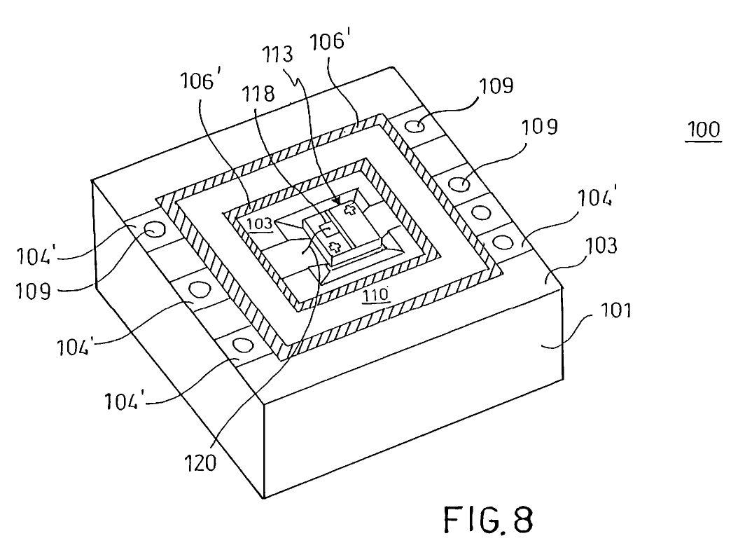

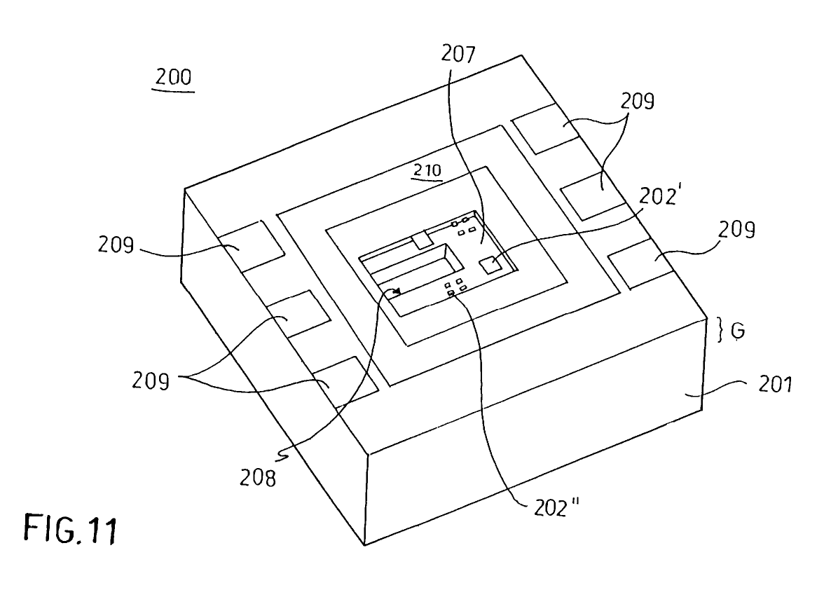

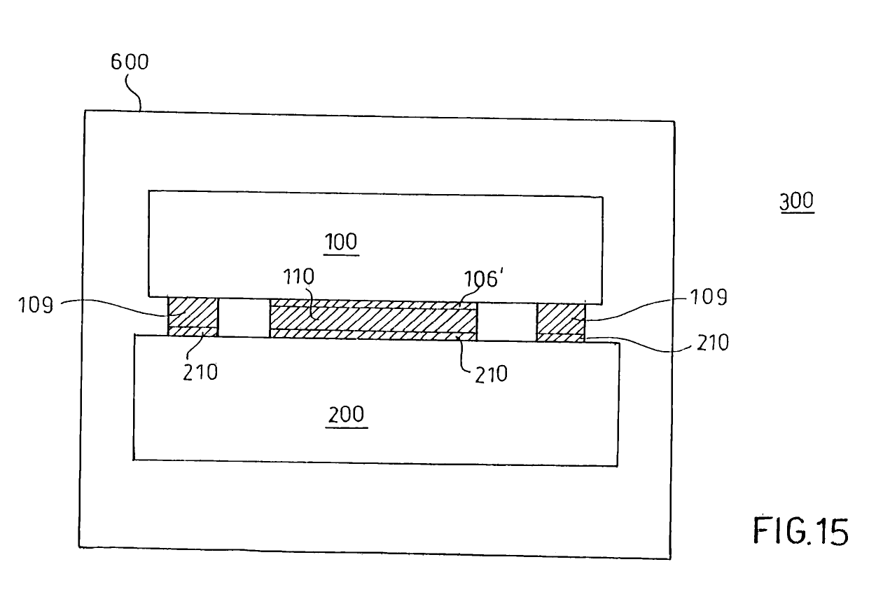

A manufacturing process will now be described of an optoelectronic module (shown in FIG. 15 and indicated with the reference number 300), in accordance with a first embodiment of the present invention. The manufacturing process of the optoelectronic module comprises the manufacture of an optoelectronic sub-module (shown in FIG. 8 and indicated with the reference 100), the manufacture of an optical sub-module (shown in FIG. 11 and indicated with the reference 200) and an assembly step of the optoelectronic sub-module 100 and the optical sub-module 200 to obtain the module 300.

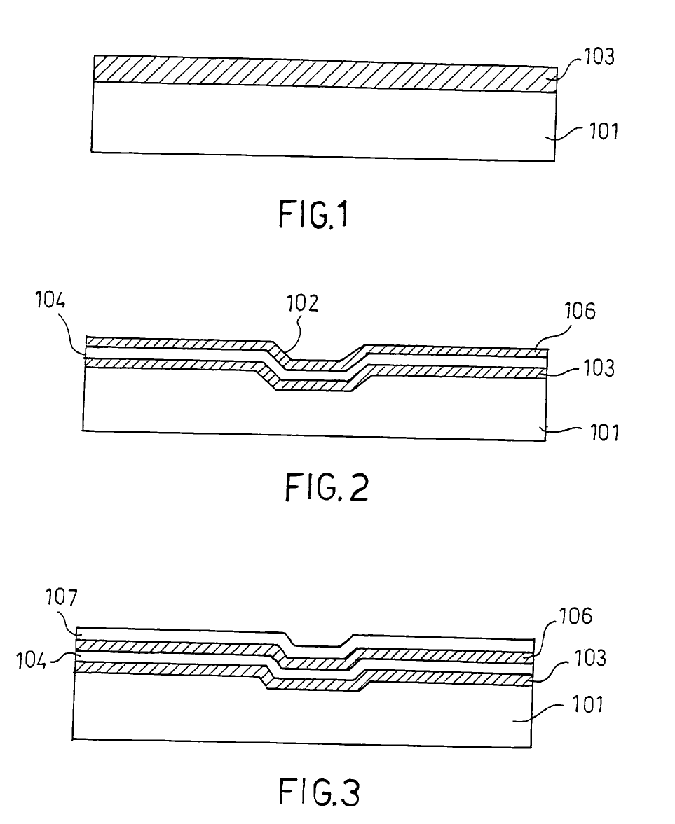

With reference to the manufacture of the optoelectronic sub-module 100, a first substrate 101 preferably made of silicon is initially provided (FIG. 1). Subsequently, on a surface 1 of the first silicon substrate 101 a first passivation layer 103 is formed of dielectric material, such as an oxide for example, and preferably silicon dioxide. The first passivation layer 103 can be achieved with deposition techniques which are well known in the integrated circuit field and can have, for example, an overall thickness in the range of 0.5-1 μm, and preferably 0.7-1 μm.

Optionally, in the first passivation layer 103 and in the first substrate 101, a first cavity 102 can be made (FIG. 2) by conventional etching steps which remove part of the first passivation layer 103 and part of the first substrate 101. The first cavity 102 will then be used to house part of an optoelectronic device.

After making the first cavity 102, the bottom of the first cavity and the lateral walls connecting with the free surface of the passivation layer 103 are covered with another passivation layer. This other passivation layer is connected with the first layer 103, and forms with this a single concave passivation layer, still indicated by reference 103.

As an alternative to the manufacturing process of the above mentioned first cavity 102, the same first cavity 102 can be made only in the substrate 101 before the deposition of the first passivation layer 103. Atop the first passivation layer 103 and atop the free surface of the first cavity 102, a first metallization layer 104 is formed with conventional methods. This metallization layer 104 is subsequently attached in a known manner to confer it with an adequate pattern. This first metallization layer 104 resulting from the etching constitutes a first electrical connection level of the optoelectronic sub-module 100.

Atop the first metallization layer 104, a second passivation layer 106 is formed with materials and methods analogous to those of the first passivation layer 103. Subsequently, the second passivation layer 106 is partially removed with lithography techniques known in the semiconductor field (for example, by dry etching or by wet etching) to define a passivation region having a particular pattern, such as a ring pattern surrounding the first cavity 102, for example.

On the ring-like passivation region obtained by the second passivation layer 106, a second metallization layer 107 (FIG. 3) is formed which is made to assume, by a corresponding etching, preferably a specific ring-like pattern surrounding the first cavity 102.

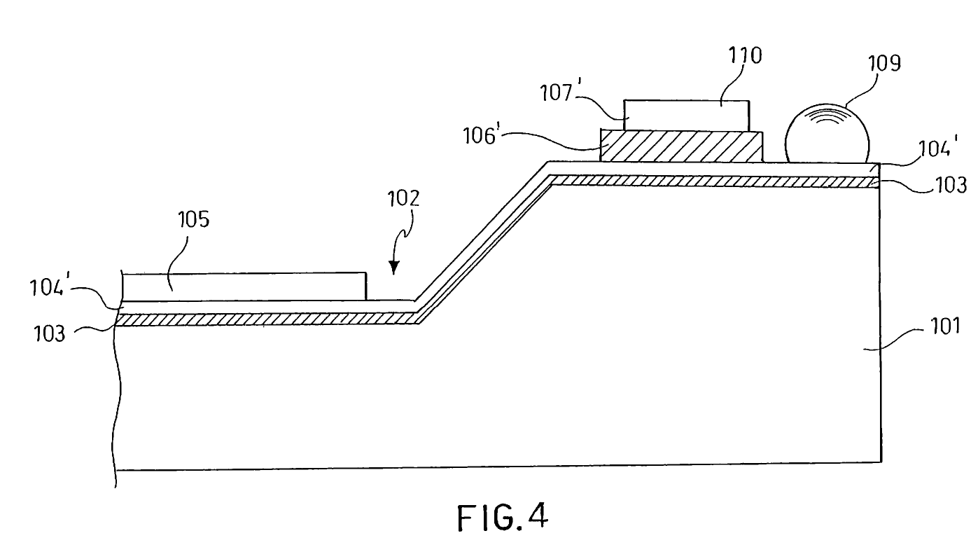

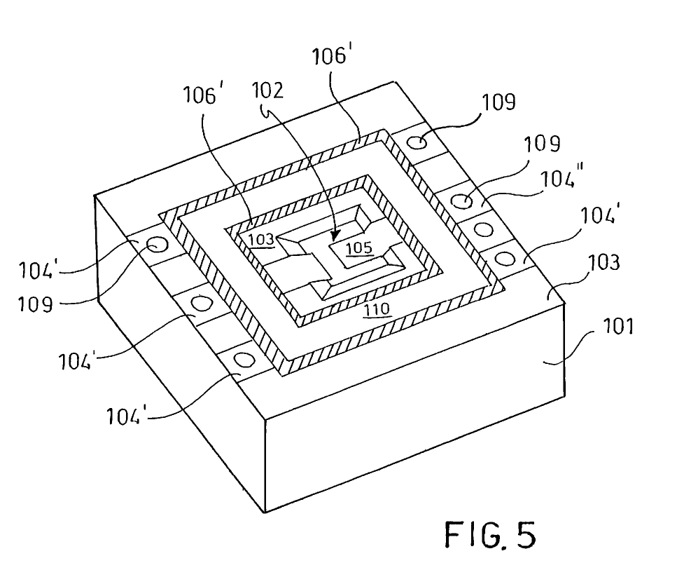

Reference will now be made to FIGS. 4 and 5. The first contact level is shown in FIG. 5 and is obtained by the first metallic layer 104 and includes according to the example a plurality of first band-like metallizations 104′ which form contact pads in proximity to the edges of the first substrate 101. One of the metallizations 104′, the central one in the described example, has a concave portion which extends inside the first cavity 102.

In FIG. 5, the peripheral regions of the passivation ring 106′ are visible, obtained from the second passivation layer 106. Such a ring 106′ has, according to the example, a quadrangular or rectangular shape, and is more internal with respect to the contact pads of the metallization 104′ surrounding the first cavity 102.

The central region of the passivation ring 106′ is not visible in FIG. 5 because it is covered by the second ring metallization, indicated with the reference number 107′, which is obtained as from the second metallization layer 107 of FIG. 3. Such a second metallization 107′ (partly visible in FIG. 4) constitutes a second, “wettable” level of electrical contact, i.e., adapted to be covered by a solder paste 110 for the assembly of the optoelectronic sub-module 100 with the optical one 200.

According to one embodiment of the invention, the solder paste 110 of an electrically conductive type is arranged on the portion of the second metallization 107′ which lies on the central region of the passivation ring 106′ to form a corresponding solder ring 110, visible in FIG. 5 (where it is represented, for the simplicity of representation, with a negligible thickness) and is also visible in the section of FIG. 4. Moreover, on each pad of the first metallization 104′, solder bumps 109 are made, preferably by using the same solder paste which forms the solder ring 110. Advantageously, the solder ring 110 and the bumps 109 can be made by a single deposition step. The solder paste which forms the solder ring 110 is, for example, a silver-tin-copper alloy, and is deposited by conventional dispensing techniques, such as screen printing.

Still referring to FIGS. 4 and 5, inside the first cavity 102 and atop part of the first central band-like metallization 104′, a soldering zone 105 is formed by a thin solder material layer. This solder material is, for example, an Au-Sn gold-tin alloy (wherein gold is present with a concentration equal to 80% and tin with a concentration equal to 20%) having a thickness in the range of 3-6 μm. The soldering zone 105 can be obtained, for example, by growth from vapor phase.

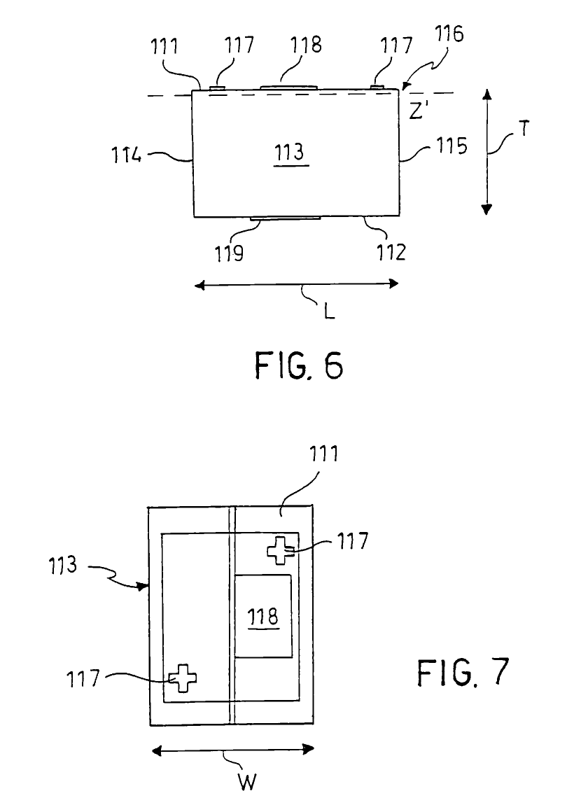

As stated above, the first cavity 102, if present, has the objective of partly housing an optoelectronic device, such as for example a semiconductor laser. The semiconductor laser 113 shown in FIGS. 6 and 7 is considered to be of a conventional type. For example, a laser compatible with the present invention is the laser model ML7CP19, produced and sold by Mitsubishi.

Such a semiconductor laser 113 is capable of emitting radiation in a wavelength range which is typical of optical communications, and in particular, equal to 1310 nm. The laser 113, in the form shown in the figures, is of a parallelepiped shape and can as an example have a width W=250 μm, a length L=300 μm and a height or thickness T1=100 μm. Such a laser comprises a first base wall 111 opposite a second base wall 112, and first lateral wall 114 opposite a second lateral wall 115. The laser 113 is provided on the second lateral wall 115 with an outlet port 116 for the electromagnetic radiation generated along an axis z′.

As shown in FIG. 7, the first base wall 111 advantageously comprises at least one marker 117, and preferably at least two markers 117 which, as will be explained in detail below, will allow the correct positioning of the optoelectronic sub-module 100 which houses the laser 113 and an electrical connection pad 118. In accordance with the described example, the second base wall 112 is also provided with an electrical connection pad 119 and may comprise positioning markers which are, in any case, not necessary for fixing the laser 113 to the optoelectronic sub-module 100 in accordance with the method described below.

With regards to the manufacturing process of the optoelectronic sub-module 100, the second base wall 112 of the laser is brought into contact with the soldering zone 105 of the first cavity 102. Subsequently, a heat treatment is carried out (for example, at 320° C. for the Au-Sn alloy) to cause the fusion of the material with which the soldering zone is made. With the cooling of the soldering zone 105, the fixing of the laser 113 to the first cavity 102 is obtained. The laser 113 is electrically connected to the first contact level 104′ by the respective electrical contact 119 and the soldering zone 105.

It is observed that the positioning procedure of the laser 113 on the soldering zone 105 is not particularly critical from a related alignment standpoint, since optical couplings are not required between the laser itself and the first substrate 101. Moreover, for the same reason, a possible limited movement of the laser 113 during the fusion of the material which forms the soldering zone 105 does not result in any particular harm.

The depth of the first housing cavity 102 of the laser 113 can be chosen to confer the same laser, and in particular its outlet port 116, the desired height with respect to the free surface of the optoelectronic sub-module to which it belongs. Moreover, the first cavity 102 can also be made by etching following the formation steps of the metallization 104 and 107 (FIG. 3) and by the employment of protection layers of the areas which are not to be removed. It is also possible to foresee no housing cavity of the laser 113, which is positioned on the soldering zone 105 made on the second electrical contact level 104′, which is flat and not concave.

FIG. 8 shows the completed optoelectronic sub-module 100, including the laser 113 provided with a wire-bonding 120 which extends between the pad 118 of the first wall 111 up to the first electrical contact level 104′. For example, the first cavity 102 has a maximum depth of about 40-50 μm, the passivation ring 106′ has a thickness of 10-20 μm and the soldering zone 100 has a thickness greater than 20 μm.

With regards to the markers 117 (FIG. 7), such markers can be of various types and are known in the optical device alignment field as mask aligners employed in the context of photolithography. For example, the markers 117 can have a cross-like form and are formed by metallization or alternatively they can be grooves made in an oxide layer.

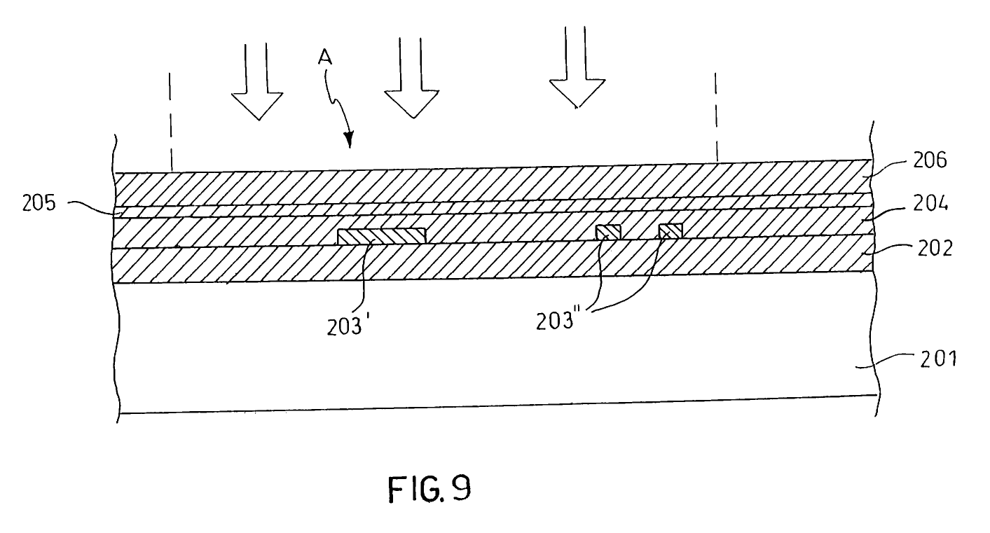

A manufacturing process of the optical sub-module 200 will now be described. FIG. 9 shows a second substrate or chip 201 in which an optical waveguide will be integrated. The second substrate 201 is preferably made of a semiconductor material, such as, according to the described example, silicon. Atop the silicon substrate 201, a layer of silicon dioxide (SiO₂) 202 has grown. This is intended to form a first lower buffer or cladding layer of an integrated optical waveguide.

Atop the first lower buffer 202, a uniform protection layer has formed, such as for example a poly-silicon or silicon nitride layer (not shown in FIG. 9). This protection layer is partially removed to define protection regions 203′ and 203″. The definition of the protection regions can be carried out, for example, by a conventional process of photolithography which comprises a masking step and an etching step of the uniform protection layer. The protection layers 203′ and 203″ are such that they remain unchanged during the etching steps of the structure which are described below.

Subsequently, atop the protection regions 203′ and 203″ and underlying lower buffer 202, another silicon dioxide layer 204 is formed. This is intended to form a second lower buffer or cladding of the optical waveguide. Moreover, atop such a second lower cladding 204, a further silicon dioxide layer 205 is formed which will constitute (after appropriate doping and definition by means of masking) a core of the waveguide.

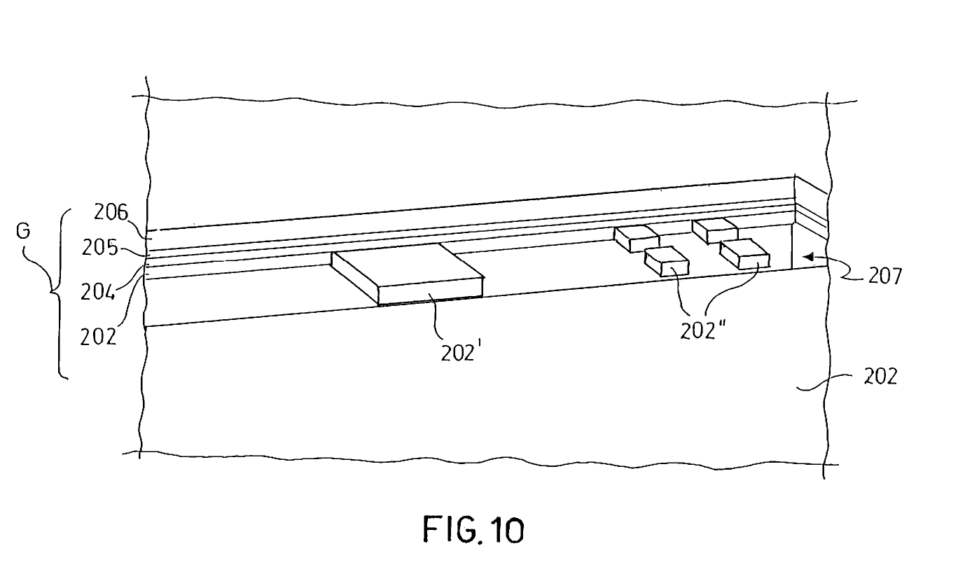

A silicon dioxide layer 206 will then be formed which extends above the core layer 205 and is intended to constitute an upper cladding or buffer layer of the waveguide. Moreover, an etching step of the integrated structure of FIG. 9 is carried out to define a second cavity 207 (shown in FIG. 10) intended to house part of the optoelectronic device (such as, for example, the laser 113), mounted in the optoelectronic sub-module 100.

To obtain the second cavity 207, beginning from the structure of overlapped layers of FIG. 9, a masking step is carried out to expose a part A of the free surface of the second buffer 206 wherein the second cavity is made. Then the etching is carried out, for example, dry anisotropic etching.

During the etching step, inside the area A defined by the mask, part of the multilayer region is removed comprising the second buffer 206, the core layer 205, and the second lower cladding 204. The protection regions 203′ and 203″ withstand the etching to protect underlying portions (aligned with these) of the first buffer layer 202 which are consequently not removed.

FIG. 10 shows a portion of the cavity 207 wherein stopper elements 202′ and 202″ are observed. These elements are formed by non-removed portions of the first buffer layer 202. As will be evident from the following description, the stoppers 202′ and 202″ are very useful for the assembly step of the optoelectronic module.

It is observed in FIG. 10 that the second cavity 207 has a depth to expose the core layer 205 towards the inner region of the cavity. The stack of layers comprising the first lower buffer layer 202, the second lower buffer layer 204, the core layer 205 and the upper buffer layer 206 make (in the non-interrupted region of the second cavity 207) an optical waveguide G integrated on the substrate 202. The structure shown in part in FIG. 10 is a component of a planar lightwave circuit (PLC) type. The formation modes (for example, the choice of dopants) of the two lower buffers 202 and 204, of the core layer 205, and of the upper buffer 206, are evident to those skilled in the art since they present the necessary refraction index values. For example, for making the core 205, the silicon dioxide layer can be doped with phosphorus or germanium.

Moreover, it is known that the protective layer from which the protection regions 203′ and 203″ are obtained can be achieved in the second lower buffer 204, as well as within the core layer 205 or in the upper buffer 206. The position and the thickness of the protection regions 203′ and 203″ and the position and the thickness of the stoppers 202′ and 202″ will be chosen to ensure that, after assembly, the laser 113 has its outlet port 116 aligned with the core layer 205 of the optical waveguide.

In FIG. 11, the obtained optical sub-module 200 is shown, beginning with the structure shown in FIG. 10, forming atop the free surface of the upper buffer 206, with conventional techniques, a third and possibly fourth metallization, which after the definition step respectively provides a plurality of contacts or pads 209 and an annular wettable region 210 (see FIG. 11). Alternatively, the second cavity 207 can also be realized after the formation of the third and fourth metallizations. Optionally, on the bottom of the second cavity 207, a third cavity 208 can be achieved (for example, with a depth equal to about 100 μm) with the object of housing wire-bondings to the laser 113. In FIG. 11, the z axis of the integrated waveguide G, included in the core layer 205, is shown with a dashed line.

The optical sub-module 200, obtained with the exemplifying methodology described above, is a structure of the PLC type which includes the optical waveguide G (provided with an inlet port available on the second cavity 207) and the stoppers 202′ and 202″ (useful for the alignment of the lasers 113).

Several exemplifying dimensions of the optoelectronic sub-module 200 include a thickness of the multilayer region 202-206 equal to about 30-40 μm; the optical axis of the guide G placed at about half the thickness of the aforesaid multilayer region; and cross sectional area of the core 205 equal to about 4 μm×4 μm.

As will be clear for those skilled in the art, the above-described manufacturing processes related to the optoelectronic sub-module 100 and the optical sub-module 200 can also be respectively carried out on a corresponding silicon wafer with a sufficient size to permit the parallel production of a plurality of sub-modules independent from each other and analogous to the above-described sub-modules 100 and 200.

After the description of the manufacture of the optoelectronic sub-module 100 shown in FIG. 8 and the optical sub-module 200 shown in FIG. 11, the assembly operations of the optoelectronic module 300 will be illustrated as shown in FIG. 15. The assembly operation can be carried out with a conventional pick-and-place manipulating apparatus (not shown), such as for example the Triad A5P model, sold by Suss Microtec (Germany) and equipped with a video camera vision system (indicated in FIG. 11 by reference SC), capable of simultaneously acquiring images of areas which are facing and opposite with regard to the video camera itself. For example, the pick-and-place manipulator apparatus and the video camera SC operate under the control of an appropriately programmed common unit.

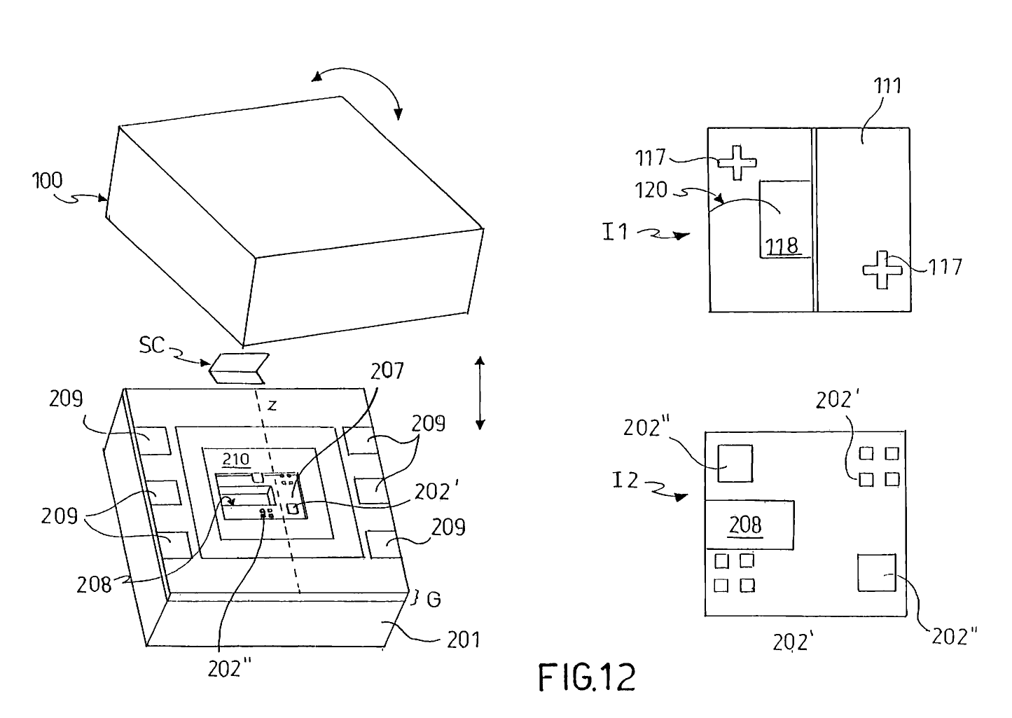

With reference to FIG. 12, the manipulator apparatus supports the optoelectronic sub-module 100 and positions it with regard to the optical sub-module 200 (or vice-versa). The two sub-modules 100 and 200 are arranged such that the wall exposed to the laser 113 (i.e., the wall 111) faces the second cavity 207 of the optical sub-module 200.

The manipulator apparatus positions the optoelectronic sub-module 100 atop the optical sub-module 200 so that the outlet port 116 of the laser 113 is aligned with the optical axis of the waveguide G integrated in the optical sub-module 200. This alignment step requires high precision. For example, misalignments less than 2 μm, preferably less than 1 μm are tolerated.

In the positioning operation of the optoelectronic sub-module 100, the video camera SC is programmed to recognize the geometry of the first base wall 111 of the laser 113, and in particular, recognizes the markers 117. Moreover, the video camera SC recognizes the geometry of the second cavity 207, and in particular, recognizes the geometry of the stoppers 202′ and 202″. FIG. 12 shows the image I1 of the first base wall 111 of the laser 113 and the image I2 of the second cavity 207 as taken by the video camera SC.

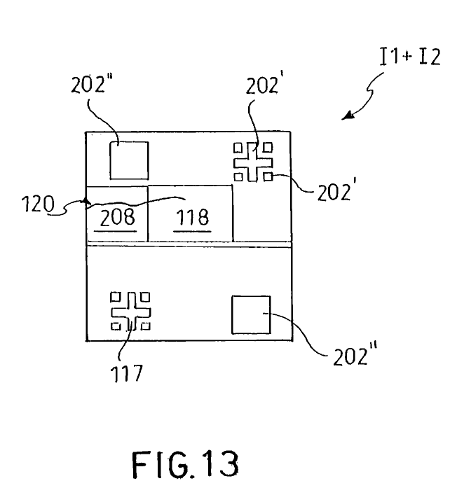

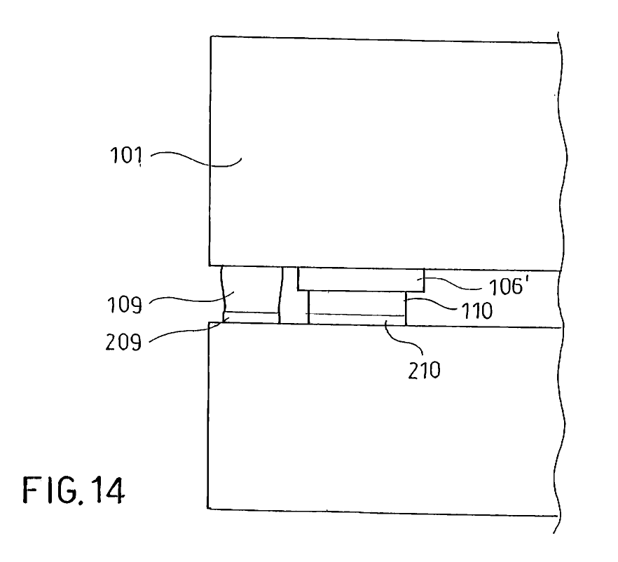

After having recognized the geometry of the two structures, the pick-and-place apparatus operates on the optoelectronic sub-module 100 (in particular moving it along a horizontal plane, parallel to the second base wall 111) so that the two images I1 and I2 coupled together are correctly superimposed, as is schematically shown in FIG. 13. Such superimposition of the two images foresees that the markers 117 are positioned in a predetermined pattern with respect to the stoppers 202′ and 202″. It is observed that, according to the described example, the stoppers 202′ and 202″ also carry out the role of markers for the alignment on the horizontal plane. It is convenient to use a pick-and-place apparatus which ensures a precise horizontal alignment with a tolerance less than 1 μm, and preferably less than 0.5 μm.

At the end of the alignment on the horizontal plane, the video camera SC is removed and the pick-and-place apparatus moves the optoelectronic sub-module 100 in a vertical direction (i.e., in a direction orthogonal to the first base wall 111), maintaining unvaried the previously achieved alignment on the horizontal plane. In such a manner, the optoelectronic sub-module 100 is superimposed on the optical sub-module 200 bearing the laser 113 inside the second cavity 207. The optoelectronic sub-module 100 lowering proceeds until the first base wall 111 is brought into contact, i.e., in abutment, with the stoppers 202′ and 202″ present in the second cavity 207 of the optical sub-module 200.

The pick-and-place apparatus, equipped with an appropriate pressure sensor, observes the contact with the stoppers 202′ and 202″ and interrupts the vertical movement of the optoelectronic sub-module 100. It is noted that the use of the markers 117 is preferred but other types of reference elements can also be employed for the alignment with any other pre-established zone of the optoelectronic sub-module 100 recognizable by the video camera SC.

With the above-described method, the optoelectronic sub-module 100 is arranged on the optical sub-module 200 so that the soldering ring 110 is superimposed on the wettable annular region 210, and the bumps 109 are facing and aligned with the pads 209 of the optical sub-module 200.

Subsequently, by way of a heat treatment, for example at a peak temperature of 250° C. for the silver-tin-copper alloy, the soldering ring 110 and the bumps 109 are brought to fusion while maintaining the two sub-modules 100 and 200 in the achieved position. At the end of the fusion and subsequent cooling, the pick-and-place apparatus releases the optoelectronic sub-module 100.

Due to the fusion of the soldering ring 110 and the subsequent cooling, the inner chamber of the optoelectronic module 300, housing the laser 113, results in a hermetically closed structure and comprises the first cavity 102 and second cavity 207, laterally bounded by a metallic wall 110 resulting from the cooling of the soldering ring. Such a chamber is adequately protected from outside humidity or dust.

It is important to observe that the above-described assembly is carried out by a passive alignment, i.e., keeping the laser 113 shut off. This is a much simpler manner than that requested by active alignment techniques, during which it is necessary to measure the optical coupling between the laser and waveguide and position the laser based on this.

The laser 113 can be electrically supplied from outside the module 300 by a first electrically conductive path which includes the pad 209 of the optical sub-module 200, the bump 109, the pad 104′ of the optoelectronic sub-module 100 and the bonding wire 120 connected to the pad 118 of the laser 113. The laser 113 can also be connected by a second conductive path comprising the other pad 119 of the laser 113 (which is found on the face opposite the pad 118), the soldering zone 105, another bump 109 of the optoelectronic sub-module 100 and another pad 209 of the optical sub-module 200.

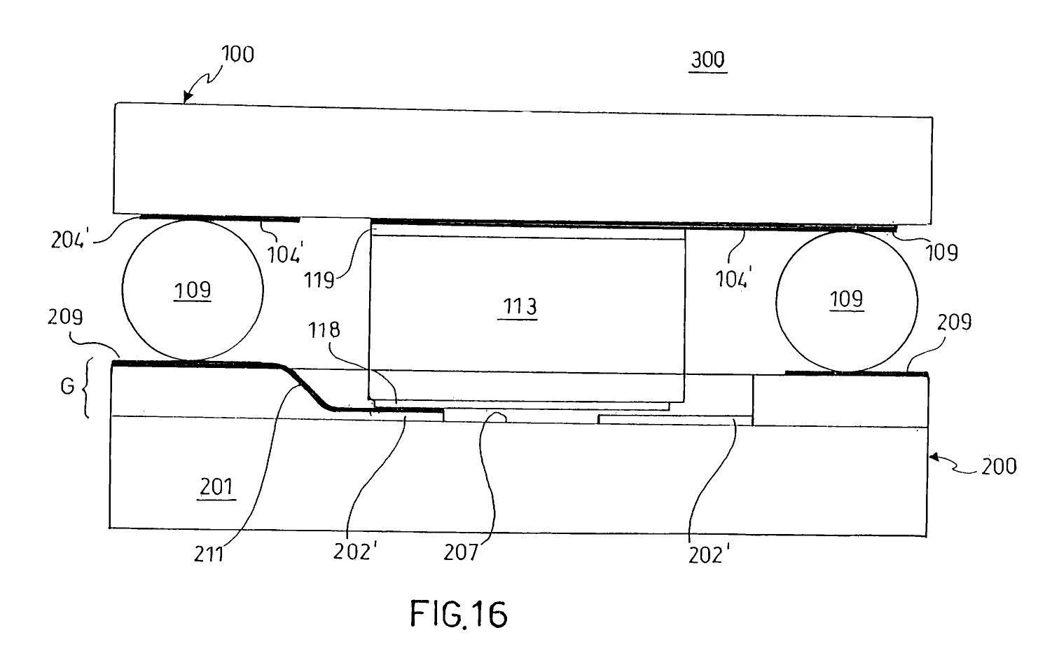

Alternatively, the bonding wire 120 does not have to be employed for the pad 118 connection. In such a case, for example, the pad 118 of the laser 113 is placed directly in electrical contact with the optical sub-module 200. In particular, as is schematically shown in FIG. 16, one of the pads 209 is connected to an electrical contact 211 which extends into the second cavity 207 atop a stopper 202′ contacting the pad 118 of the laser 113. According to the example shown in FIG. 16, the optoelectronic sub-module 100 is not provided with the first cavity 102 made for the sub-modules of the other figures.

The optoelectronic module 300 is then advantageously housed in an external container, schematically shown in FIG. 15 and indicated with the reference 600. This external container 600 is preferably a plastic material, such as epoxy or thermoplastic resins. One such container 600, such as for example, a pre-molded two-piece box fixable by a conventional resin, is advantageously of a non-hermetic type.

Alternatively to the laser or other optical transmitter 113 such as a VCSEL (Vertical Cavity Surface Emitting Laser), the optoelectronic module 300 can contain another type of optoelectronic device such as an optical receiver, and in particular a photodiode 113′. In such a case, as schematically shown in FIG. 22, the optical sub-module 200 can also comprise a reflecting element MR (i.e., a mirror made with techniques known in the integrated optics field) which permit coupling the optical radiation between the integrated guide G and the absorption port 116′ present on a bottom wall of the device 113′. In an analogous manner, with the VCSEL as device 113, the mirror MR permits coupling the optical radiation emitted vertically from the port 116′ of the VCSEL 113 with the guide G.

With particular reference to the embodiment, schematically shown in FIG. 22, the chamber formed by the first cavity 102 and by the second cavity 207 can be filled with a transparent resin for a known radiation of interest, having an appropriate refraction index to increase the coupling efficiency between the optical port 116′ and the guide G. Such a transparent resin could also be employed for all the other embodiments of the present invention.

According to a further version of the present invention, the solder ring 110 and the bumps 109 can be attained not on the optoelectronic sub-module 100 but on the optical sub-module 200, with techniques analogous to those described above. This has the advantage of avoiding the remelting of the solder ring 110 and bumps 109 during the step of soldering the optoelectronic device 113 onto the optoelectronic sub-module 100.

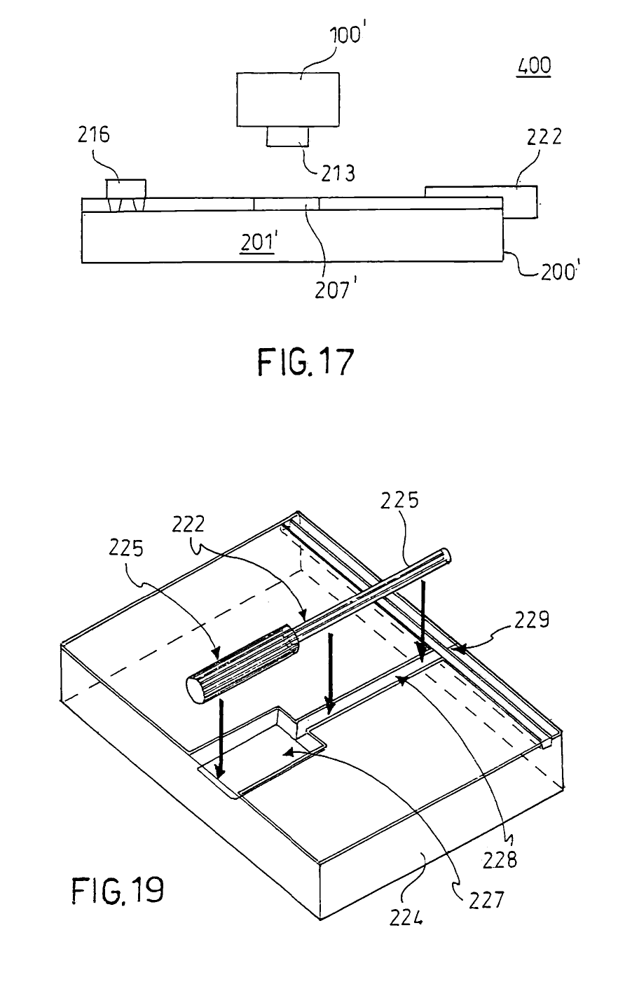

The teachings of the present invention are also applicable to more complex optoelectronic modules than those described above. For example, a triplexer module 400 is shown in FIG. 17, made according to a particular embodiment of the invention. The triplexer is an apparatus which, as is known, is capable of transmitting an optical signal at a predetermined wavelength (for example, 121 nm) and receiving optical signals at two different wavelengths (for example, 1490 nm and 1455 nm). Typically, the triplexer is used as a home termination for fiber optics telecommunication systems and is widely used in the United States for receiving a digital channel (data transmission) and an analog channel (cable TV) on optical carriers.

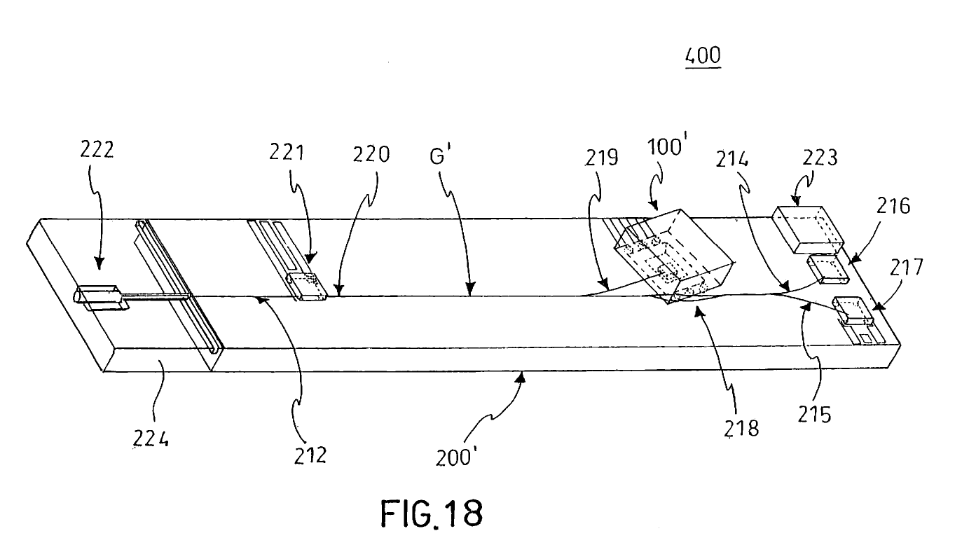

With reference to FIGS. 17 and 18, constituent components and parts of the triplexer 400 analogous to those previously described for the optoelectronic module 300 have been indicated with the same reference number used before but are now followed by a prime.

The triplexer 400 comprises respectively a base sub-module 200′ and an electro/optical sub-module 100′, analogous to the optical sub-module 200 and the optoelectronic sub-module 100 described above. The optical sub-module 200′ is a PLC and comprises an integrated optical guide G′ having an end 212 optically coupled with an optical fiber 213 appropriately fixed to the base sub-module 200′. The integrated optical guide G′ is, for example, suitable for the propagation of WDM optical signals (Wavelength-Division Multiplexing) with wavelengths in the range of 1300 nm-1500 nm. Moreover, the integrated optical guide G′ is connected, at an end opposite the end 212, to an integrated wavelength multiplexer/demultiplexer 218.

The integrated multiplexer/demultiplexer 218 comprises a first outlet 214 for a first wavelength (1490 nm, for example) optically coupled to a digital photodiode 216, and a second outlet 215 for a second wavelength (1550 nm, for example) optically coupled to an analog photodiode 217. Advantageously, the digital photodiode 216 is electrically connected to a transimpedance amplifier TIA 223 which permits amplification of the electrical signal resulting from the optical to electrical conversion.

The integrated optical waveguide G′ is provided with a first directional optical coupler 219 connected to a laser 113 fixed to the electro/optical sub-module 100′ and with a second directional optical coupler 220 connected to a monitoring photodiode 221, intended to monitor the laser emission 113. In the area of the base sub-module 200′ intended to face the electro/optical sub-module 100′, stoppers are made which are analogous to the 202′ and 202″ stoppers.

The laser 113 of the electro/optical module 100′ permits generation of optical radiation which by way of the integrated waveguide G′ is introduced into an optical fiber 222, appropriately fixed to the base sub-module 200′. It is observed that the base sub-module 200′, unlike the sub-module 200 described above, is not only associated with the sub-module containing the laser 113 but also acts as a support for other optoelectronic or optical devices.

According to a particular embodiment of the invention, the digital photodiode 216, the analog photodiode 217 and the monitoring photodiode 221 can be fixed to the base module 200′ by soldering in a conventional manner. The optical coupling of each of such devices with the respective integrated waveguide section G′ can be carried out by integrated mirrors (not shown) on the base module 200′. Alternatively, several or all of the abovementioned photodiodes can be fixed to an optoelectronic module analogous to the 100 module (described above with reference to FIGS. 1-8) and then fixed to the base module 200′ through a method analogous to that described for the optoelectronic module 300.

As is visible in FIG. 19, the optical fiber 222 of the triplexer 400 is fixed to a support portion 224 of the base sub-module 200′. The optical fiber 222 has a section 225 provided with an outer coating, intended to be housed in a cavity 227 made in the support portion 224, and a second section of bare fiber 226, intended to be housed in a groove 228 of the support portion 224. One end of the optical fiber of the bare fiber section 225 is aligned with the core 229 of the integrated waveguide G′.

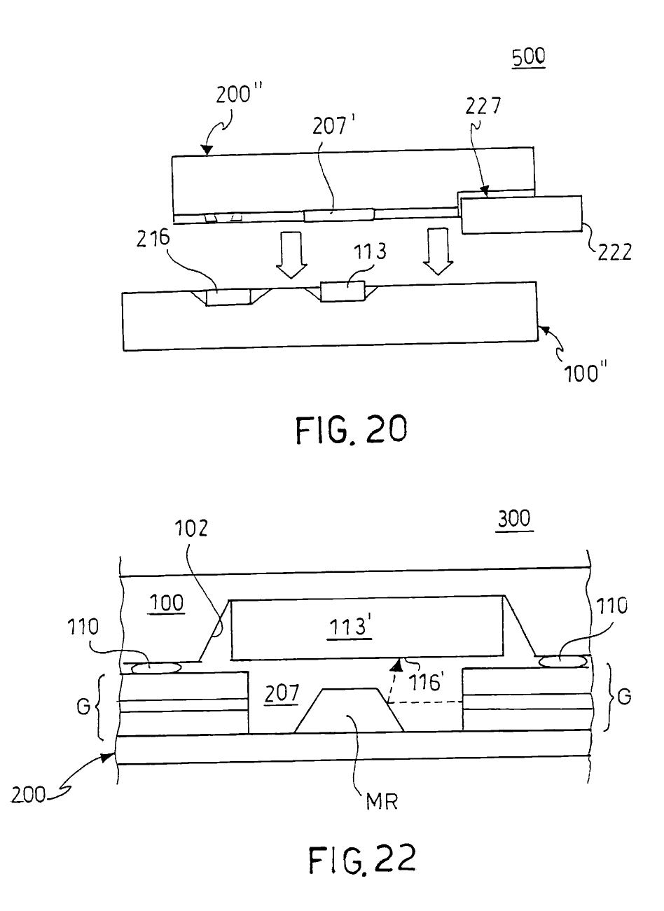

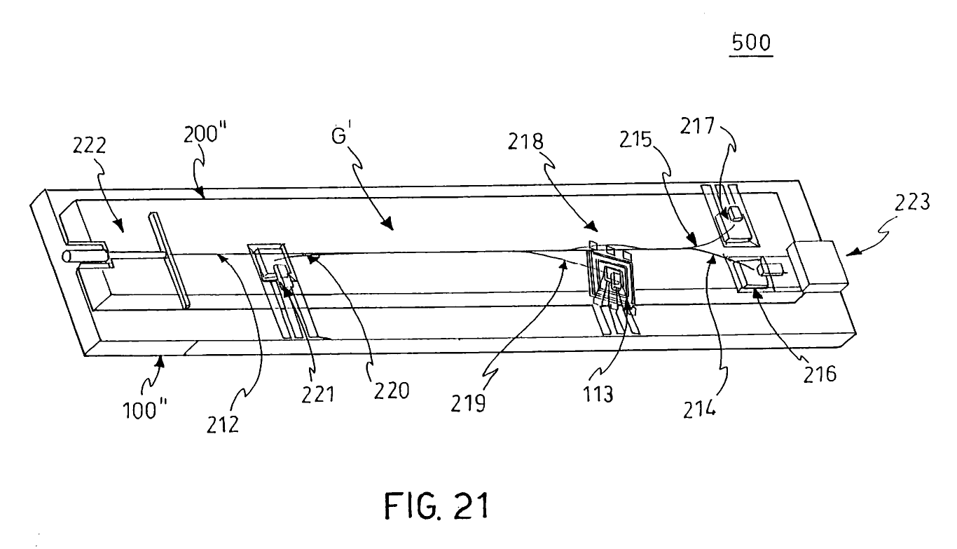

FIGS. 20 and 21 show a triplexer 500 realized according to an alternative embodiment of the present invention. Constituent components and parts of the second triplexer 500 analogous to those described above for the first triplexer 400 are indicated with the same reference number. The second triplexer 500 includes a respective optoelectronic base sub-module 100″ (analogous to the sub-module 100 of the optoelectronic module 300) on which the laser 113, the photodiodes 216, 217, 221 and the transimpedance amplifier 223 are fixed. The optoelectronic base sub-module 100″ is assembled with a further optical sub-module 200″ (of PLC type) to which the optical fiber 222 is also fixed.

The assembly of the second triplexer 500 can take place by a method analogous to that described above with reference to the assembly of the optoelectronic module 300, considering that the further optical sub-module 200″ is provided with stoppers analogous to the stoppers 202′ and 202″ shown with optical-module reference 200. Analogous to the module 300 and the first triplexer 400, also the laser 113 of the second optoelectronic module is found housed in a hermetic chamber.

The present invention is very advantageous since it permits avoiding the use of external metallic containers of the optoelectronic module, considerably reducing the cost of the module itself. In fact, due to the hermetic nature of the chamber which houses the optoelectronic device of the present invention, it is possible to use an external plastic container, not metallic or ceramic, with a reduction of manufacturing costs with respect to modules of a known type equal to about 50%.

Another considerable advantage is due to the fact that the teachings of the invention permit manufacturing optical modules having high alignment precision between the components, employing an entirely passive alignment method, which is simpler and less costly.

A further advantage of the present invention is tied to the mode with which the oxide stoppers 202′ and 202″ are made. The method described is straightforward to actuate and fully compatible with the integrated waveguide manufacturing processes.

The manufacturing and assembly operations of the optoelectronic module 300 or triplexers 400 and 500 are not particularly critical, and permit obtaining optical alignments with adequate precision for the applications of interest, requiring the use of conventional mounting equipment (for example, the pick-and-place apparatuses). Naturally, the relative ease and economical method with which the modules of the invention can be manufactured contribute to their limited final cost.

1-41. (canceled)

42. An optoelectronic module comprising:
a first sub-module having a cavity formed therein and comprising an integrated waveguide having a first optical port accessible from the cavity;
a second sub-module facing said first sub-module;
a wall extending from said first sub-module to said second sub-module and surrounding the cavity to define a hermetically closed chamber; and
an optoelectronic device coupled to at least one of said first and second sub-modules and contained within the hermetically closed chamber, said optoelectronic device having a second optical port coupled to the first optical port of said first sub-module.

43. An optoelectronic module according to claim 42, further comprising an external plastic container for housing said first and second sub-modules, said wall and said optoelectronic device.

44. An optoelectronic module according to claim 42, wherein said optoelectronic device comprises first and second opposing walls, a first electrical contact on said first wall and a second electrical contact on said second wall; and wherein said second sub-module comprises a substrate, first and second contact layers on said substrate, and a soldering layer coupling said first and second contact layers to said first electrical contact of said optoelectronic device.

45. An optoelectronic module according to claim 44, wherein said first sub-module comprises third and fourth contact layers accessible from external the optoelectronic module.

46. An optoelectronic module according to claim 44, further comprising a bond wire extended between said first and second contact layers of said optoelectronic device opposite said first wall.

47. An optoelectronic module according to claim 45, wherein said first electrical contact is in direct contact with said first contact layer, and said second electrical contact is in direct contact with said fourth contact layer.

48. An optoelectronic module according to claim 45, further comprising contact pads on said first and second contact layers to electrically contact said third and fourth contact layers, said contact pads to be connected to an external power device for providing power to said optoelectronic device.

49. An optoelectronic module according to claim 42, wherein the wall comprises at least one of lead-tin and silver-tin-copper.

50. An optoelectronic module according to claim 44, wherein said second sub-module comprises a solder material arranged on part of said second contact layer to couple said optoelectronic device to said second sub-module.

51. An optoelectronic module according to claim 50, wherein said solder material comprises a gold-tin alloy.

52. An optoelectronic module according to claim 42, wherein said first sub-module comprises at least one stopper element in the cavity to be in abutment with at least one of said second electrical contact and said second wall for alignment of said second optical port with said first optical port.

53. An optoelectronic module according to claim 52, wherein said optoelectronic device comprises at least one positioning marker on said second wall to align with said at least one stopper element.

54. An optoelectronic module according to claim 42, wherein said optoelectronic device comprises at least one of an optical receiver, a semiconductor laser, an optical transmitter, and a photodiode.

55. An optoelectronic module according to claim 52, wherein said first sub-module is configured as a planar lightwave circuit comprising a substrate, and wherein said integrated waveguide comprises at least one lower buffer layer on said substrate, a waveguide core on said at least one lower buffer layer, and an upper buffer layer on said waveguide core.

56. An optoelectronic module according to claim 55, wherein said substrate comprises silicon, and wherein said lower and upper buffer layers and said waveguide core comprise silicon dioxide.

57. An optoelectronic module according to claim 44, wherein said second sub-module comprises a first passivation layer between said substrate and said first and second contact layers, and said first and second contact layers comprise a metallic material.

58. An optoelectronic module according to claim 42, wherein said second sub-module has another cavity for receiving part of said optoelectronic device.

59. An optoelectronic module according to claim 58, wherein said substrate of said second sub-module comprises silicon, and wherein said first passivation layer comprises silicon dioxide.

60. An optoelectronic module according to claim 42, further comprising:
an optical fiber optically coupled to one end of said integrated guide for propagation of a wavelength-division signal;
a digital photodiode optically coupled to an opposite end of said integrated guide for reception of a first signal at a first wavelength; and
an analog photodiode optically coupled to the opposite end of said integrated guide for reception of a second signal at a second wavelength;
said optical fiber and said digital and analog photodiodes cooperate with said first and second sub-modules, said wall and said optoelectronic device so that the optoelectronic module is configured as a triplexer.

61. An optoelectronic module according to claim 60, wherein said optical fiber is coupled to said second sub-module.

62. An optoelectronic module according to claim 60, wherein said optical fiber is coupled to said first sub-module.

63. An optoelectronic module according to claim 60, wherein said optoelectronic device comprises an optical signal transmitter coupled to a first branch of said integrated waveguide to transmit an optical signal along said optical fiber.

64. An optoelectronic module according to claim 63, further comprising a monitoring receiver coupled to a second branch of said integrated waveguide for monitoring emission of said optical signal transmitter.

65. An optoelectronic module according to claim 55, wherein said at least one stopper element comprises a portion of said at least one lower buffer layer.

66. An optoelectronic module according to claim 65, wherein said at least one stopper element comprises silicon dioxide.

67. A triplexer comprising:
a first sub-module having a cavity formed therein and comprising an integrated waveguide having a first optical port accessible from the cavity;
a second sub-module facing said first sub-module;
a wall extending from said first sub-module to said second sub-module and surrounding the cavity to define a hermetically closed chamber; and
an optoelectronic device coupled to at least one of said first and second sub-modules and contained within the hermetically closed chamber, said optoelectronic device having a second optical port coupled to the first optical port of said first sub-module;
an optical fiber optically coupled to one end of said integrated guide for propagation of a wavelength-division signal;
a digital photodiode optically coupled to an opposite end of said integrated guide for reception of a first signal at a first wavelength; and
an analog photodiode optically coupled to the opposite end of said integrated guide for reception of a second signal at a second wavelength.

68. A triplexer according to claim 67, wherein said optoelectronic device comprises first and second opposing walls, a first electrical contact on said first wall and a second electrical contact on said second wall; and wherein said second sub-module comprises a substrate, first and second contact layers on said substrate, and a soldering layer coupling said first and second contact layers to said first electrical contact of said optoelectronic device.

69. A triplexer according to claim 67, wherein said first sub-module comprises third and fourth contact layers accessible from external the optoelectronic module; and wherein said first electrical contact is in direct contact with said first contact layer, and said second electrical contact is in direct contact with said fourth contact layer; and further comprising contact pads on said first and second contact layers to electrically contact said third and fourth contact layers, said contact pads to be connected to an external power device for providing power to said optoelectronic device.

70. A triplexer according to claim 67, wherein the wall comprises at least one of lead-tin and silver-tin-copper.

71. A triplexer according to claim 67, wherein said first sub-module comprises at least one stopper element in the cavity to be in abutment with at least one of said second electrical contact and said second wall for alignment of said second optical port with said first optical port; and wherein said optoelectronic device comprises at least one positioning marker on said second wall to align with said at least one stopper element.

72. A triplexer according to claim 67, wherein said optoelectronic device comprises at least one of an optical receiver, a semiconductor laser, an optical transmitter, and a photodiode.

73. A triplexer according to claim 71, wherein said first sub-module is configured as a planar lightwave circuit comprising a substrate, and wherein said integrated waveguide comprises at least one lower buffer layer on said substrate, a waveguide core on said at least one lower buffer layer, and an upper buffer layer on said waveguide core.

74. A triplexer according to claim 67, wherein said second sub-module comprises a first passivation layer between said substrate and said first and second contact layers, and said first and second contact layers comprise a metallic material.

75. A triplexer according to claim 67, wherein said second sub-module has another cavity for receiving part of said optoelectronic device.

76. A triplexer according to claim 67, wherein said optoelectronic device comprises an optical signal transmitter coupled to a first branch of said integrated waveguide to transmit an optical signal along said optical fiber.

77. A triplexer according to claim 67, further comprising a monitoring receiver coupled to a second branch of said integrated waveguide for monitoring emission of said optical signal transmitter.

78. A manufacturing process for an optoelectronic module comprising:
forming a first sub-module having a cavity formed therein and comprising an integrated waveguide having a first optical port accessible from the cavity;
forming a second sub-module facing the first sub-module;
coupling an optoelectronic device to at least one of the first and second sub-modules, the optoelectronic device having a second optical port;
assembling the first sub-module and the second sub-module so that the optoelectronic device is at least partially contained in the cavity, and the second optical port is coupled to the first optical port of the first sub-module; and
forming a wall extending from the first sub-module to the second sub-module and surrounding the cavity to define a hermetically closed chamber wherein the optoelectronic device is housed.

79. A manufacturing process according to claim 78, wherein forming the first sub-module comprises:
providing a substrate;
wherein the integrated waveguide comprises a multilayer region comprising at least one lower buffer layer on the substrate, a waveguide core on the at least one lower buffer layer, and an upper buffer layer on the waveguide core;
forming in the multilayer region at least one protection region;
removing part of the multilayer region to form the cavity so that the at least one protection region blocks removal of underlying portions of the multilayer region; and
removing the at least one protection region so that the underlying portions function as stopper elements in abutment with the optoelectronic device.

80. A manufacturing process according to claim 79, wherein the at least one lower buffer layer comprises a first lower buffer layer and a second lower buffer layer superimposed on the first lower buffer layer, the at least one protection region being formed on the first lower buffer layer before forming the second lower buffer layer, and wherein the stopper elements are portions of the first lower buffer layer.

81. A manufacturing process according to claim 78, wherein forming the second sub-module comprises forming first and second contact layers on a substrate, and forming a first passivation layer between the substrate and the first and second contact layers, and the first and second contact layers comprising metallic material.

82. A manufacturing process according to claim 81, wherein coupling the optoelectronic device to at least one of the first and second sub-modules comprises soldering a wall of the optoelectronic device to part of the second contact layer.

83. A manufacturing process according to claim 78, wherein assembling the first and second sub-modules is performed in a passive manner without power-on the optoelectronic device.

84. A manufacturing process according to claim 79, wherein assembling the first and second sub-modules comprises:
positioning the first sub-module with respect to the optoelectronic device coupled to the second sub-module by aligning positioning markers provided on an additional wall of the optoelectronic device with the stopper elements in the cavity of the first sub-module; and
moving the first sub-module with regards to the second sub-module until the additional wall is in abutment with the stopper elements.

85. A manufacturing process according to claim 78, wherein forming the wall comprises arranging a solder paste to surround the cavity; and heating the solder paste to cause its fusion.

86. A manufacturing process according to claim 78, further comprising housing the first and second sub-modules, the wall and the optoelectronic device with an external plastic container.
